(19) United States
(12) Patent Application Publication
(10) Pub. No.: US 2026/0161479 A1
(43) Pub. Date: Jun. 11, 2026

(54) RETRIEVAL AND REDISTRIBUTION OF DECOUPLED ELECTRONIC RESOURCES

(71) Applicant: ADP, Inc., Roseland, NJ (US)

(72) Inventor: Jyotsna Manikantan, Edison, NJ (US)

(73) Assignee: ADP, Inc., Roseland, NJ (US)

(21) Appl. No.: 18/970,685

(22) Filed: Dec. 5, 2024

(51) Int. Cl. G06F 9/50; G06F 9/451; G06F 21/62

(52) U.S. Cl. CPC G06F 9/5061; G06F 9/451; G06F 21/6218

(57) ABSTRACT

A system can include one or more processors coupled with memory. The one or more processors can determine that a first collection of resources is coupled with the first entity, detect that a second collection of resources has been decoupled from a second entity, cause a user interface to display a first element configured to receive an input to cause an aggregation of the second collection of resources into the first collection of resources based on the first collection of resources being coupled with the first entity, retrieve an electronic form associated with the aggregation of the second collection of resources into the first collection of resources, cause the user interface to display a second element configured to receive information for one or more fields included in the electronic form, and transmit one or more signals to provide the electronic form to a third entity.

### TECHNICAL FIELD

This application is generally related to computing technology, and, more particularly, to data distribution.

### SUMMARY

Aspects of the technical solutions described herein are directed to a data retrieval and redistribution architecture to associate multiple accounts with a single destination. The data retrieval and redistribution architecture can implement connective intelligence (e.g., artificial intelligence, machine learning, pre-trained transformers, etc.). The connective intelligence can retrieve account information that corresponds to one or more account identifiers, save the account information, and initiate requests to redistribute, transfer, reallocate, relocate, or otherwise aggregate the account information into a new account. Aspects of the technical solutions described herein can provide a bridge to connect accounts, which have accumulated over a given period of time, with a singular or uniform destination. The connective intelligence can receive one or more inputs, which trigger the connective intelligence to converge or aggregate accounts into a singular account.

The data retrieval and redistribution architecture of the technical solutions described herein can provide a flexible computational approach to automatically discover associations between accounts and account identifiers. The technical solutions described herein are rooted in computing technology, such as where a user has established multiple online accounts. In some aspects, such online accounts can be across multiple online systems (i.e., account providers). The technical solutions described herein facilitate identifying such multiple accounts and aggregating them into a single account, which may be a new account. Further, in some aspects, the multiple (old) accounts are canceled or closed and replaced by a single account. The technical solutions described herein provide a practical application by facilitating such an identification and aggregation of multiple accounts. Further, the technical solutions described herein perform such identification and aggregation maintaining data security, sensitivity, and accuracy across the multiple accounts. For example, the data retrieval and redistribution architecture can provide, to client systems or client devices, prompts for an indication of one or more account identifiers. The data retrieval and redistribution architecture can query or otherwise search one or more databases to detect one or more accounts that may be associated with the account identifiers. In instances where one or more accounts are found to have been decoupled from or otherwise disassociated with one or more entities, the data retrieval and redistribution architecture can initiate an aggregation function to associate the accounts with a singular account or entity. For example, the data retrieval and redistribution architecture can aggregate a first account with a second account when the first account is indicated as not being administered by one or more entities (e.g., decoupled). As another example, the data retrieval and redistribution architecture can aggregate a first account responsive to detecting that a service provider or account provider (e.g., an entity), that established the account, is no longer overseeing activity of the account. Advantageously, the data retrieval and redistribution architecture can detect decoupled accounts without affirmative notice, from a client system, regarding the decoupled accounts. Moreover, the aggregation of the accounts can prevent or limit a loss of resources from the account.

Moreover, the data retrieval and redistribution architecture can implement one or more machine learning models to detect anomalies or variances between one or more collection of resources and decoupled entities. For example, the one or more machine learning models can be trained, using training data, to identify one or more collection of resources that have been decoupled from entities. The one or more machine learning models can be trained to detect when account credentials (e.g., access codes, verification data, tokens, etc.) have been halted or otherwise stopped. Advantageously, the one or more machine learning models can detect anomalies when a collection of resources has been decoupled from an entity but nevertheless has not yet been aggregated with a second collection of resources. As another example, the one or more machine learning models can detect anomalies when one or more collection of resources are initiated or otherwise instantiated without an aggregation of one or more second collection of resources.

Furthermore, the one or more machine learning models can prevent or limit fraud by restricting the aggregation of one or more collection of resources to devices or entities that have been authenticated. For example, the one or more machine learning models can maintain or otherwise access, from one or more third-party systems, access codes or access information that authenticate devices. Stated otherwise, the one or more machine learning models can maintain authentication information for which one or more one or more devices can be authenticated. The one or more machine learning models can restrict or limit aggregation of resources, based on the authentication information. For example, the one or more machine learning models may prevent aggregation of a first collection of resources with a second collection of resources prior to authentication of a device requesting the aggregation. As another example, the one or more machine learning model can facilitate the aggregation of resources only after one or more account identifiers have been verified.

As described herein, one or more collections of resources can be decoupled from an entity based on or responsive to at least one of a disassociation between account identifiers and the entity, a detachment between account identifiers and the entity, a separation between one or more accounts and the entity, or a detachment between accounts and entities. For example, a collection of resources can become decoupled, from an entity, responsive to a disconnect between an underlying account and the entity. As another example, the collection of resources can become decoupled, from an entity, responsive to one or more changes with an account holder. Additionally, or alternatively, a decoupling of a collection of resources, from an entity, can include at least one of a disconnect, a termination link, a break link, an access block, a rejection, or a halt in an agreement between an account holder and the entity.

At least one aspect is directed to a system. The system can include one or more processors. The one or more processors can couple with memory. The one or more processors can determine, for an account identifier, that a first collection of resources, established by a first entity, is coupled with the first entity. The one or more processors can detect, responsive to determination that the first collection of resources is coupled with the first entity, for the account identifier, that a second collection of resources, established by a second entity, has been decoupled from the second entity. The one or more processors can cause a user interface to display a first element configured to receive an input to cause an aggregation of the second collection of resources into the first collection of resources based on the first collection of resources being coupled with the first entity. The one or more processors can retrieve, responsive to receipt of the input, an electronic form associated with the aggregation of the second collection of resources into the first collection of resources. The one or more processors can cause the user interface to display a second element configured to receive information for one or more fields included in the electronic form. The one or more processors can transmit, responsive to receipt of the information for the one or more fields included in the electronic form, one or more signals to provide the electronic form to a third entity configured to perform the aggregation of the second collection of resources into the first collection of resources.

At least one aspect is directed to a method. The method can include determining, by one or more processing circuits, for an account identifier, that a first collection of resources, established by a first entity, is coupled with the first entity. The method can include detecting, by the one or more processing circuits, responsive to determining that the first collection of resources is coupled with the first entity, for the account identifier, that a second collection of resources, established by a second entity, has been decoupled from the second entity. The method can include causing, by the one or more processing circuits, a user interface to display a first element configured to receive an input to cause an aggregation of the second collection of resources into the first collection of resources based on the first collection of resources being coupled with the first entity. The method can include retrieving, by the one or more processing circuits, responsive to receipt of the input, an electronic form associated with the aggregation of the second collection of resources into the first collection of resources. The method can include causing, by the one or more processing circuits, the user interface to display a second element configured to receive information for one or more fields included in the electronic form. The method can include transmitting, by the one or more processing circuits, responsive to receipt of the information for the one or more fields included in the electronic form, one or more signals to provide the electronic form to a third entity configured to perform the aggregation of the second collection of resources into the first collection of resources.

At least one aspect is directed to a non-transitory computer readable medium. The non-transitory computer readable medium can include one or more instructions stored thereon. The one or more instructions can be executable by a processor. The processor can determine, for an account identifier, that a first collection of resources, established by a first entity, is coupled with the first entity. The processor can detect, responsive to determining that the first collection of resources is coupled with the first entity, for the account identifier, that a second collection of resources, established by a second entity, has been decoupled from the second entity. The processor can cause a user interface to display a first element configured to receive an input to cause an aggregation of the second collection of resources into the first collection of resources based on the first collection of resources being coupled with the first entity. The processor can retrieve, responsive to receipt of the input, an electronic form associated with the aggregation of the second collection of resources into the first collection of resources. The processor can cause the user interface to display a second element configured to receive information for one or more fields included in the electronic form. The processor can transmit, responsive to receipt of the information for the one or more fields included in the electronic form, one or more signals to provide the electronic form to a third entity configured to perform the aggregation of the second collection of resources into the first collection of resources.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, according to this disclosure.

FIG. 2 depicts an example computer architecture, according to this disclosure.

FIG. 3 depicts an example system, according to this disclosure.

FIG. 4 depicts an example method for retrieving and redistributing resources, according to this disclosure.

FIG. 5 depicts a block diagram of an example computing system for implementing the embodiments of the present solution, including, for example, the system depicted in FIG. 1, and the method depicted in FIG. 4.

### DETAILED DESCRIPTION

Aspects of the technical solutions described herein with reference to the figures, which are illustrative examples of the technical solutions. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

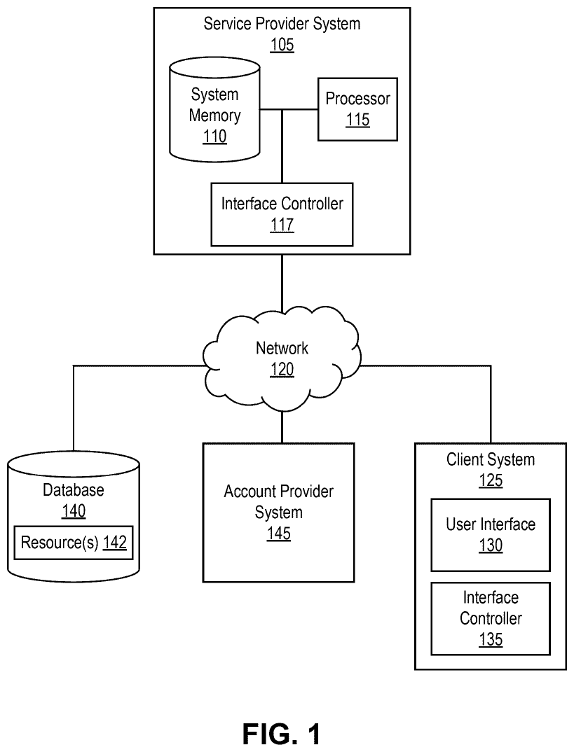

FIG. 1 depicts an example system, according to this disclosure. As illustrated by way of example in FIG. 1, a system 100 can include at least one of a service provider system 105, a network 120, a client system 125, a database 140, an account provider system 145. In an aspect, the system 100 according to an architecture as discussed herein can provide a combination of information retrieval, account redistribution, resource aggregation, and form population.

The network 120 can include any type or form of network. The geographical scope of the network 120 can vary widely and the network 120 can include a body area network (BAN), a personal area network (PAN), a local-area network (LAN), e.g., Intranet, a metropolitan area network (MAN), a wide area network (WAN), or the Internet. The topology of the network 120 can be of any form and can include, e.g., any of the following: point-to-point, bus, star, ring, mesh, or tree. The network 120 can include an overlay network which is virtual and sits on top of one or more layers of other networks 120. The network 120 can be of any such network topology as known to those ordinarily skilled in the art capable of supporting the operations described herein. The network 120 can utilize different techniques and layers or stacks of protocols, including, e.g., the Ethernet protocol, the Internet protocol suite (TCP/IP), the ATM

(Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 120 can include a type of a broadcast network, a telecommunications network, a data communication network, or a computer network.

The service provider system 105 can include a physical computer system that is or may be operatively coupled with one or more components of the system 100. The service provider system 105 can include a virtual computing system, an operating system, and a communication bus to effect communication and processing. The service provider system 105 can include a system memory 110, a processor 115, and an interface controller 117.

The processor 115 can execute one or more instructions associated with the service provider system 105. The processor 115 can include an electronic processor, an integrated circuit, or the like including one or more of digital logic, analog logic, digital sensors, analog sensors, communication buses, volatile memory, nonvolatile memory, and the like. The processor 115 can include, but is not limited to, at least one microcontroller unit (MCU), microprocessor unit (MPU), central processing unit (CPU), graphics processing unit (GPU), physics processing unit (PPU), embedded controller (EC), or the like. The processor 115 can include a memory operable to store one or more instructions for operating components of the processor 115 and operating components operably coupled to the processor 115. For example, the one or more instructions can include one or more of firmware, software, hardware, operating systems, embedded operating systems. The processor 115 or the service provider system 105 generally can include one or more communication bus controllers to effect communication between the processor 115 and the other elements of the service provider system 105.

The interface controller 117 can link the service provider system 105 with one or more of the network 120, the client system 125, the database 140, and the account provider system 145, by one or more communication interfaces. A communication interface can include, for example, an application programming interface (“API”) compatible with a particular component of the service provider system 105, or the client system 125. The communication interface can provide a particular communication protocol compatible with a particular component of the service provider system 105 and a particular component of the client system 125. The interface controller 117 can be compatible with particular content objects and can be compatible with particular content delivery systems corresponding to particular content objects, structures of data, types of data, or any combination thereof. For example, the interface controller 117 can be compatible with transmission of text data or binary data structured according to one or more metrics or data of the client system 125.

One or more components of the system 100 can include or utilize one or more models trained with machine learning. For example, the service provider system 105 can execute or implement models trained using machine learning techniques, models trained with the same or different types of training data, or models trained or configured to receive different types of input or provide different types of output. Example machine learning techniques can include neural networks, such as a generative adversarial network (e.g., a generator neural network and a discriminator neural network that are trained simultaneously through adversarial training), a variational autoencoder (e.g., an autoencoder neural network that learns to generate new data samples by modeling the underlying probability distribution of the data), an autoregressive model, or other types of neural networks (e.g., deep learning models, convolution neural networks, recurrent neural networks, or transformers). Transformers can refer to or include a type of deep learning model architecture configured for natural language processing, including, for example, bidirectional encoder representations (“BERT”), generative pre-trained transformers, text-to-text transformer, transformer-XL, robustly optimized BERT, or distilled BERT. Other types of machine learning techniques can include supervised learning models, unsupervised learning models, semi-supervised learning models, or reinforcement learning models. For example, a supervised machine learning technique can include a support vector machine used for classification and regression tasks. Given a set of labeled training data, a support vector machine can identify the hyperplane that separates the data into classes with the largest possible margin (e.g., distance between the hyperplane and nearest data points from each class).

The system memory 110 can store data associated with the system 100. The system memory 110 can include one or more hardware memory devices to store binary data, digital data, or the like. The system memory 110 can include one or more electrical components, electronic components, programmable electronic components, reprogrammable electronic components, integrated circuits, semiconductor devices, flip flops, arithmetic units, or the like. The system memory 110 can include at least one of a non-volatile memory device, a solid-state memory device, a flash memory device, or a NAND memory device. The system memory 110 can include one or more addressable memory regions disposed on one or more physical memory arrays. A physical memory array can include a NAND gate array disposed on, for example, at least one of a particular semiconductor device, integrated circuit device, and printed circuit board device.

The client system 125 can include a computing system associated with a database system. For example, the client system 125 can correspond to a cloud system, a server, a distributed remote system, or any combination thereof. For example, the client system 125 can include an operating system to execute a virtual environment. The operating system can include hardware control instructions and program execution instructions. The operating system can include a high-level operating system, a server operating system, an embedded operating system, or a boot loader. The client system 125 can include a user interface 130 and an interface controller 135.

The user interface 130 can include one or more devices to receive input from a user or to provide output to a user. For example, the user interface 130 can correspond to a display device to provide visual output to a user and one or more or user input devices to receive input from a user. For example, the input devices can include a keyboard, mouse or touch-sensitive panel of the display device, but are not limited thereto. The display device can display at least one or more presentations as discussed herein, and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The display device can be housed at least partially within the client system 125.

The interface controller 135 can link the client system 125 with one or more of the network 120, the service provider system 105, and the account provider system 145, by one or more communication interfaces. A communication interface can include, for example, an application programming interface (“API”) compatible with a particular component of the service provider system 105, or the client system 125. The communication interface can provide a particular communication protocol compatible with a particular component of the service provider system 105 and a particular component of the client system 125. The interface controller 135 can be compatible with particular content objects and can be compatible with particular content delivery systems corresponding to particular content objects, structures of data, types of data, or any combination thereof. For example, the interface controller 135 can be compatible with transmission of text data or binary data structured according to one or more metrics or data of the service provider system 105.

The database 140 can store, maintain, or keep one or more data structures. For example, the database 140 can store information as one or more vectors. As another example, the database 140 can include one or more physical rows or virtual rows of memory for which one or more sets of information can be stored. The database 140 can store data structures that represent or include information associated with accounts (e.g., account information). The account information can include indications of an entity (e.g., an account provider, an institution, a company, or corporation) that have created or otherwise provided one or more accounts. The account information can be linked to or otherwise associated with one or more resources. For example, a first set of account information may be linked to a first amount of resources such that querying a database, using the first set of account information, can return information pertaining to the first amount of resources. As another example, the account information may include one or more account identifiers which indicate or otherwise correspond to an entity responsible for or otherwise providing the account.

The database 140 can store one or more resources 142 (or information associated with the resources 142). For example, the database 140 may store or maintain one or more data structures that represent the resources 142. As another example, the database 140 may store the resources 142 as one or more entries in a vector or table. The resources 142 can correspond to or be associated with one or more accounts or account identifiers. For example, a first resource 142 may be associated with a first account identifier. In some embodiments, the first resource 142 or information associated with the first resource 142 may be retrieved via the first account identifier. For example, the service provider system 105 may transmit one or more application programming interface (API) calls to the database 140. The API calls may include or otherwise indicate the first account identifier. The service provider system 105 may receive one or more responses that include the first resource 142.

The account provider system 145 can produce, generate, provide, or otherwise initiate one or more accounts. For example, the account provider system 145 can produce one or more accounts that store or otherwise hold the resources 142. The account provider system 145 can include or refer to at least one of an institution, an establishment, a depository, or commercial entity. The account provider system 145 can facilitate distribution or movement of the resources 142. For example, the account provider system 145 can decouple one or more resources from a first account and couple the one or more resources with a second account. As another example, the account provider system 145 can service or otherwise maintain the accounts associated with the resources 142.

The service provider system 105 can cause the display or presentation of one or more graphical user interfaces. For example, the service provider system 105 can transmit signals to the client system 125 that cause the client system 125 to present, via a display, a graphical user interface. As another example, the service provider system 105 can control execution of a mobile application, stored by or on the client system 125, such that the mobile application causes the client system 125 to provide a graphical user interface.

The service provider system 105 can receive one or more selections. For example, the service provider system 105 can receive selections via the user interface 130. As another example, the service provider system 105 can receive information that indicates one or more selections that were received via a user interface. The service provider system 105 can receive selections that indicate one or more requests.

The service provider system 105 can receive the selections during one or more chatbot sessions. For example, the service provider system 105 can receive or provide information to the client system 125 while operating a chatbot session. The service provider system 105 can receive the selections as one or more natural language prompts. As another example, the service provider system 105 can receive the selections via one or more interactions with elements of a user interface. The elements can include items such as checkboxes, toggles, text boxes, etc.

The service provider system 105 can determine one or more collections of resources that are coupled with one or more entities. For example, the service provider system 105 can determine that a first collection of resources (e.g., a first resource 142) is coupled with a first entity. The service provider system 105 can determine that the first resource 142 is coupled with the first entity based on information in the database 140 indicating that the first entity is providing services regarding the first resource 142. For example, the service provider system 105 can detect that the first entity is adding or otherwise appending additional resources into the first resource 142.

The service provider system 105 can determine, for one or more account identifiers, one or more collections of resources that are coupled with entities. For example, the service provider system 105 can query the database 140, using an account identifier, to detect one or more resources 142 that are associated with the account identifier. The service provider system 105 can retrieve or otherwise access account information, corresponding to the account identifier, to detect or otherwise identify an entity coupled with the collection of resources. For example, the service provider system 105 can retrieve information that indicates an activation date or an instantiation data for the collection of resources. The service provider system 105 can also retrieve information that indicates which entity activated or instantiated the collection of resources.

The service provider system 105 can detect that one or more second collection of resources (e.g., second resources 142) have be decoupled from entities. For example, the service provider system 105 can detect that a collection of resources has been tagged or otherwise marked as inactive (e.g., no contributions, no appending, no aggregations, etc.) by an entity. The service provider system 105 can detect decoupled resources based on one or more prompts provided to the client system 125. For example, the service provider system 105 can transmit a prompt, to the client system 125, to provide one or more account identifiers associated with one or more accounts or one or more collection of resources. The service provider system 105 can transmit the prompt responsive to an indication or notification that a member has been added to or otherwise associated with a given entity. The indication may include information pertaining to or otherwise associated with the member. For example, the information may include an indication of one or more account identifiers linked to the member.

The service provider system 105 can cause one or more user interfaces to be displayed. For example, the service provider system 105 can transmit one or more signals which cause the user interface 130 to display a graphical user interface. The user interfaces can include one or more elements or portions. For example, the user interfaces can include text box, input windows, selectable icons, or other possible interactable features. The user interfaces can include elements to receive one or more inputs. For example, the user interface can include checkboxes or toggles to receive one or more inputs. The inputs can cause an aggregation of one or more collections of resources. For example, the user interfaces may include a message, a window, or a prompt that provides an indication of the decoupled resources. The user interfaces can include elements to receive inputs to indicate a request to aggregate resources. For example, the user interfaces can include a button having a prompt that asks the member to provide an indication to aggregate the resources.

The service provider system 105 can retrieve one or more electronic forms (e.g., forms) responsive to receipt of an input. For example, the service provider system 105 can retrieve an electronic form to aggregate decoupled resources into one or more active collections of resources. As another example, the service provider system 105 can retrieve an electronic from to request disbursement or distribution of the resources to a corresponding member. The service provider system 105 can retrieve the electronic forms from the database 140. For example, the service provider system 105 can query, according to identifiers associated with the entities, the database 140 to detect electronic forms associated with the entities.

The service provider system 105 can cause one or more user interfaces to display elements to receive information associated with the forms. For example, the service provider system 105 can digitally display or otherwise present the forms. The forms may include one or more fields (e.g., elements) for which information may be provided to or otherwise entered. The service provider system 105 can display the form via the user interface 130.

The service provider system 105 can transmit one or more signals to the account provider system 145. For example, the service provider system 105 can transmit one or more electronic messages, to the account provider system 145, to provide information to the account provider system 145. The electronic messages may include or otherwise indicates one or more forms. For example, the service provider system 105 may transmit one or more signals that include a form that includes information to redistribute or otherwise relocate one or more resources. As another example, the service provider system 105 can transmit one or more signals to cause the account provider system 145 to aggregate or otherwise combine resources, from one or more accounts, into a single collection of resources.

The service provider system 105 can receive one or more responses. For example, the service provider system 105 can receive an indication that the account provider system 145 received the form (e.g., request to aggregate one or more collection or resources). As another example, the service provider system 105 can receive confirmation or acknowledgment, from the account provider system 145, regarding receipt of the form. The service provider system 105 can update or otherwise display one or more user interfaces to indicate receipt of the form. For example, the service provider system 105 can cause the client system 125 to display a user interface that includes a banner or message to indicate receipt of the form.

The service provider system 105 provide one or more elements via a user interface. For example, the service provider system 105 can provide an element to receive one or more access codes. The access codes can refer to or include authentication information or credentials. For example, the access codes can indicate or verify authorization to access or modify one or more collection of resources (e.g., the resources 142). As another example, the access codes can include tokens or encrypted data strings.

The service provider system 105 can receive, via the elements of the user interface, receive access codes from the client system 125. For example, the service provider system 105 can receive the access codes responsive to one or more inputs to the elements. As another example, the service provider system 105 can detect one or more sets of information (e.g., the access codes) entered into or otherwise provided to the elements. The service provider system 105 can query the database 140 using the access codes. For example, the service provider system 105 can transmit one or more API calls, which include the access codes, to the database 140. The database 140 can return or otherwise indicate one or more collection of resources (e.g., the resources 142) for which the access codes provide access to.

The service provider system 105 can verify or otherwise validate the collection or resources based on the query. For example, the service provider system 105 can confirm that the resources are accessible via the access codes. As another example, the service provider system 105 can verify that the client system 125 is authorized to request an aggregation of the resources 142. The service provider system 105 can update or provide one or more user interfaces that include an indication of a verification. For example, the service provider system 105 can update a user interface to include a window or overlay which presents a message to indicate that the collection of resources was verified. As another example, the service provider system 105 can update the user interface to include a banner having information associated with the collection of resources.

The service provider system 105 can one or more sets of information. For example, the service provider system 105 can receive information associated with one or more collection of resources. The service provider system 105 can receive the information based on one or more access codes. For example, the service provider system 105 can utilize the access code, for a given collection of resources, to retrieve information from the database 140. As another example, the service provider system 105 can access or otherwise view information associated with the given collection of resources via the access code.

The service provider system 105 can update or otherwise display one or more user interfaces having information associated with a collection of resources. For example, the service provider system 105 can display a user interface that includes an indication of the amount or value of the collection of resources. As another example, the service provider system 105 can display a user interface that indicates or identifies an entity associated with the collection of resources.

The service provider system 105 can receive one or more sets of information based on account identifiers. For example, the service provider system 105 can receive information that indicates or identifies one or more collection of resources that are associated with an account identifier. As another example, the service provider system 105 can receive information that identifies a given account provider system 145 that provides the collection of resources.

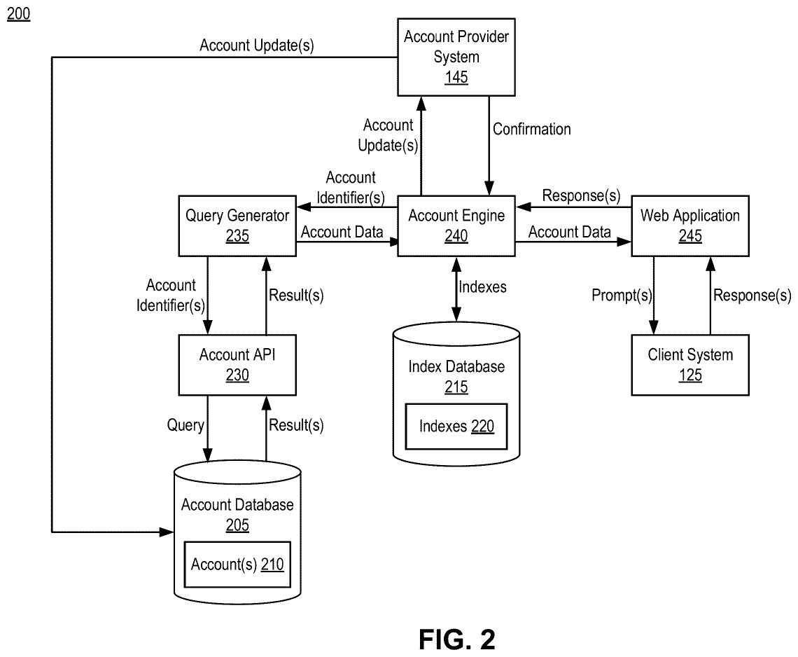

FIG. 2 depicts an example computer execution architecture, according to this disclosure. As illustrated by way of example in FIG. 2, a computer execution architecture 200 can be one or more instructions stored at the system memory 110 to cause one or more components of the system 100, the service provider system 105, the client system 125, or any combination thereof, but is not limited thereto, to carry out one or more actions. For example, the computer execution architecture 200 can include computational hardware or software integrated with the service provider system 105. The computer execution architecture 200 can refer to or illustrate communication between one or more separate or discrete systems.

The computer execution architecture 200 can include one or more of an account database 205, an index database 215, an account API 230, a query generator 235, an account engine 240, a web application 245, the client system 125, or the account provider system 145. The system 100 or one or more components thereof can represent or include one or more components of the computer execution architecture 200. For example, the database 140 can represent the account database 205 and the index database 215. As another example, the service provider system 105 can implement or call the account API 230, the query generator 235, the account engine 240, or the web application 245.

As shown in FIG. 2, the various components, devices, systems, or elements of the computer execution architecture 200 can communicate or otherwise exchange information with one another. For example, the web application 245 can represent or implement an interface between the account engine 240 and the client system 125. Stated otherwise, the client system 125 may communicate with the account engine 240 via the web application 245.

The web application 245 can provide one or more messages (e.g., prompts) to the client system 125. The prompts can include requests for one or more responses. For example, the web application 245 can provide a prompt to the client system 125 to provide an indication of an account identifier. As another example, the web application 245 can prompt a prompt to the client system 125 to provide an indication of an access code. The web application 245 can receive one or more responses from the client system 125. For example, the web application 245 can receive an input which indicates an account identifier. As another example, the web application 245 can receive an input which identifies an entity that provides one or more accounts 210. As even another example, the web application can receive one or more inputs which identify or otherwise indicate one or more collection of resources (e.g., resources 142).

The web application 245 can forward or otherwise provide the responses to the account engine 240. For example, the web application 245 can provide the account identifiers to the account engine 240. As another example, the web application 245 can provide one or more forms or data structures to the account engine 240. The account engine 240 can interface with the query generator 235 to generate one or more search query or database prompts. For example, the account engine 240 can provide the account identifier to the query generator 235. As another example, the account engine 240 can provide an indication of one or more collection of resources for the query generator 235 to search for. The query generator 235 may query the account database 205 for one or more matches between information associated with a first collection of resources and information associated with a second collection of resources. For example, the query generator 235 may query the account database 205 for a match between identifying information for a first account 210 and identifying information for a second account 210.

The query generator 235 can transmit one or more signals via or to the account API 230 to query the account database 205. For example, the query generator 235 can transmit one or more API calls to the account API 230 to query the account database 205. The query generator 235 can receive one or more responses or results. For example, the account API 230 can return one or more accounts 210 associated with the account identifier. As another example, the account API 230 can return one or more status indicators regarding whether one or more collections of resources are coupled or decoupled from an entity.

The query generator 235 may return the results of querying the account database 205 to the account engine 240. For example, the query generator 235 may provide an indication of one or more identified accounts 210. As another example, the query generator 235 may provide information that identifies one or more resources (e.g., collection of resources) that are coupled or decoupled from an entity. The account engine 240 may provide or otherwise display the results of querying the account database 205, via the web application 245. For example, the web application 245 may refer to a user interface and the account engine 240 can cause the user interface to display or otherwise present the results of the query.

The account engine 240 can cause the web application 245 to display one or more elements that can receive inputs. For example, the account engine 240 can cause the web application 245 to display a text box for which the client system 125 can enter information. As another example, the account engine 240 can cause the web application 245 to display one or more prompts for which the client system 125 can accept or reject. The account engine 240 can prompt the client system 125 to provide one or more inputs to accept an aggregation of one or more collection of resources. For example, the account engine 240 can identify a collection of resources, which has been decoupled from an entity, and prompt the client system 125 to accept an aggregation of the collection of resources with one or more collections of resources coupled with a second entity.

The account engine 240 can receive, via the web application 245, one or more responses to the prompt to aggregate a collection of resources. For example, the account engine 240 can receive an input which indicates that the client system 125 provided an indication to accept the aggregation. The account engine 240 can facilitate the aggregation of the collection of resources. For example, the account engine 240 can populate or generate one or more forms to submit with the account provider system 145. As another example, the account engine 240 can provide one or more forms of authentication (e.g., access codes, tokens, etc.) to the account provider system 145 to establish authorization by the client system 125. The account engine 240 can identify one or more collection of resources for aggregation. For example, the account engine 240 can identify a first collection of resources for which a second collection of resources are to be aggregated with.

The account engine 240 can transmit one or more signals, to the account provider system 145, that cause the account provider system 145 to update the account database 205. For example, the account engine 240 can cause the account provider system 145 to aggregate or otherwise combine a first account 210 with a second account 210. As another example, the account engine 240 can cause the account provider system 145 to redistribute one or more collection of resources (e.g., first resources 142) from a first account 210 into a second account 210.

The account engine 240 can receive confirmation or verification of the aggregation of the collection of resources. For example, the account engine 240 can receive one or more messages, from the account provider system 145, that indicate when the collection of resources has been aggregated. The account engine 240 can receive the confirmation as one or more indexes 220. For example, the account engine 240 can receive a data structure (e.g., an index 220) that represents or includes the aggregation of a first collection of resources and a second collection of resources. Stated otherwise, the index 220 can represent the combination of the first collection of resources and the second collection of resources as a singular account or representation. The account engine 240 can store or otherwise maintain the indexes 220 in the index database 215. For example, the account engine 240 can write or otherwise ingest the indexes 220 into the index database 215.

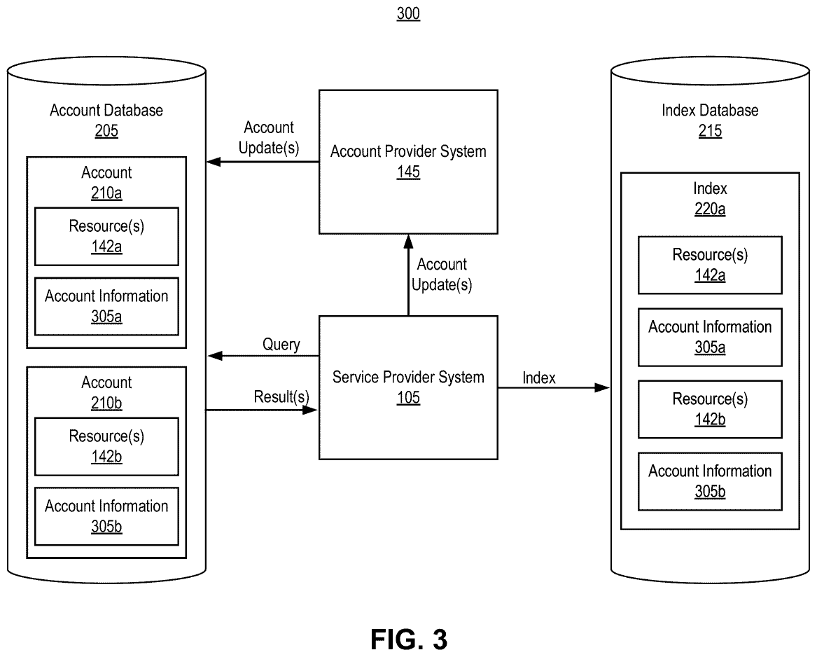

FIG. 3 depicts a system, according to this disclosure. As illustrated by way of example in FIG. 3, a system 300 can include the account database 205, the service provider system 105, the account provider system 145, and the index database 215. The system 300 or one or more portions thereof can implement or otherwise execute the computer execution architecture 200. The service provider system 105 can push or otherwise provide one or more account updates to the account provider system 145. For example, the service provider system 105 can provide indications of one or more updates or changes the accounts 210.

The account database 205 can store information associated with one or more accounts (e.g., the accounts 210). For example, the account database 205 can store a data structure that represents an account 210a. As another example, the account database 205 can store a data structure that represents an account 210b. The account 210a and the account 210b can be associated with one or more resources or one or more sets of information. For example, the account 210a can include resources 142a and account information 305a. The resources 142a can refer to or include a collection of resources associated with the account 210a. Resources 142b can refer to or include a collection of resources associated with the account 210b. The service provider system 105 can publish one or more account updates to the account provider system 145 to cause the account provider system 145 to aggregate or otherwise combine the resources 142a and the resources 142b.

The service provider system 105 can monitor or otherwise evaluate the account database 205 to detect an aggregation of the resources 142a and the resources 142b. For example, the service provider system 105 can detect that the resources 142a and the resources 142b have been aggregated based on one or more changes to the resources 142b. The service provider system 105 can aggregate the resources 142a with the resources 142b by modifying information associated with one the resources. For example, the service provider system 105 can modify the account information 305b such that the account information 305b reflects that the resources 142b have been aggregated with the resources 142a. As another example, the service provider system 105 can modify the account information 305b such that the account information 305b includes the account information 305a.

The service provider system 105 can cause one or more user interfaces to display elements that indicate when resources have been aggregated. For example, the service provider system 105 can cause a user interface to display a banner that provides a message which indicates an aggregation of the resources 142a and the resources 142b.

The service provider system 105 can store or otherwise maintain aggregated resources or information associated with the aggregated resources as the indexes 220. The service provider system 105 can store the indexes 220 as data structures in the index database 215. An index 220a may include information or resources associated with one or more accounts. For example, the index 220a include the resources 142a, the account information 305a, the resources 142b, and the account information 305b. Stated otherwise, the index 220a represents an aggregation or combination of the resources 142a and the resources 142b.

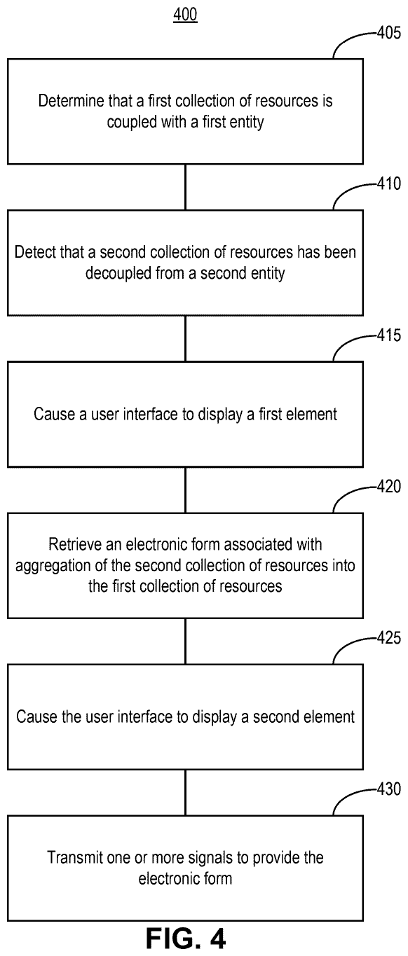

FIG. 4 depicts an example method for retrieving and redistributing resources, according to this disclosure. At least one of the system 100, the service provider system 105, the client system 125, or any combination thereof, or any component thereof, can perform method 400. At 405, the method 400 can determine that a first collection of resources is coupled with a first entity. For example, the determination can be responsive to a query of a database. The method 400 can determine that a database includes one or more sets of information which indicate that the first entity is maintaining or otherwise performing one or more actions pertaining to the first collection of resources. For example, the set of information can be detecting based on a query of the database. The set of information can include or indicate that the first entity is coupled with the first collection of resources.

At 410, the method 400 can detect that a second collection of resources has been decoupled from a second entity. For example, the method 400 can detect information associated with the second collection of resources reflects that the second entity halted or otherwise stopped performing actions regarding the second collection of resources. As another example, the method 400 can query the database to detect one or more accounts for which an account provider system has indicated as being decoupled.

At 415, the method 400 can cause a user interface to display a first element. The first element can receive one or more inputs. For example, the first element can receive an input to cause an aggregation of the second collection of resources into the first collection of resources. The input can indicate to aggregate the second collection or resources based on the first collection of resources being coupled with the first entity.

At step 420, the method 400 can retrieve an electronic form. The electronic form can be associated with the aggregation of the second collection of resources into the first collection of resources. For example, the method 400 can retrieve an electronic form associated with an account provider system that can aggregate the second collection of resources into the first collection of resources.

At step 425, the method 400 can cause the user interface to display a second element. The second element can receive information for one or more fields included in the electronic form. For example, the second element can include one or more text boxes or input elements for which information can be entered into.

At step 430, the method 400 can transmit one or more signals. For example, the method 400 can transmit an electronic message to a third entity that can perform the aggregation of the second collection of resources into the first collection of resources. The third entity can include an account provider system or other third-party system that can aggregate the second collection of resources into the first collection of resources. The method 400 can transmit an electronic message that includes or otherwise indicates the electronic form.

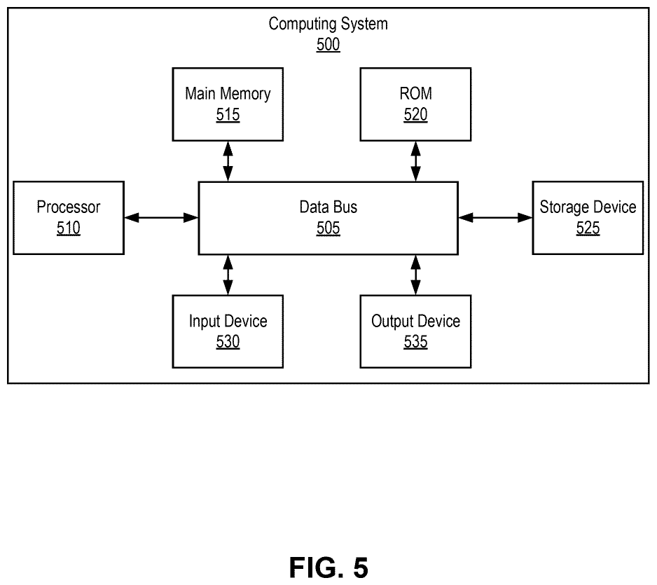

FIG. 5 depicts a block diagram of a computing system 500 for implementing the embodiments of the technical solutions discussed herein, in accordance with various aspects. FIG. 5 illustrates a block diagram of an example computing system 500. Computing system 500 can be used to implement elements of the systems and methods described and illustrated herein. Computing system 500 can be included in and run any device (e.g., a server, a computer, a cloud computing environment, or a data processing system).

Computing system 500 can include at least one data bus 505 or other communication device, structure, or component for communicating information or data. Computing system 500 can include at least one processor 510 or processing circuit coupled to the data bus 505 for executing instructions or processing data or information. Computing system 500 can include one or more processors 510 or processing circuits coupled to the data bus 505 for exchanging or processing data or information along with other computing systems 500. Computing system 500 can include one or more main memories 515, such as a random access memory (RAM), dynamic RAM (DRAM), cache memory or other dynamic storage device, which can be coupled to the data bus 505 for storing information, data, and instructions to be executed by the processor(s) 510. Main memory 515 can be used for storing information (e.g., data, computer code, commands, or instructions) during execution of instructions by the processor(s) 510.

Computing system 500 can include one or more read only memories (ROMs) 520 or other static storage device 525 coupled to the data bus 505 for storing static information and instructions for the processor(s) 510. Storage devices 525 can include any storage device, such as a solid state device, magnetic disk or optical disk, which can be coupled to the data bus 505 to persistently store information and instructions.

Computing system 500 can be coupled via the data bus 505 to one or more output devices 535, such as speakers or displays (e.g., liquid crystal display or active matrix display) for displaying or providing information to a user. Input devices 530, such as keyboards, touch screens or voice interfaces, can be coupled to the data bus 505 for communicating information and commands to the processor(s) 510. Input device 530 can include, for example, a touch screen display (e.g., output device 535). Input device 530 can include a cursor control, such as a mouse, a trackball, or cursor direction keys, for communicating direction information and command selections to the processor(s) 510 for controlling cursor movement on a display.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors 510 in a multi-processing arrangement can also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
determine, for an account identifier, that a first collection of resources, established by a first entity, is coupled with the first entity;
detect, responsive to determination that the first collection of resources is coupled with the first entity, for the account identifier, that a second collection of resources, established by a second entity, has been decoupled from the second entity;
cause a user interface to display a first element configured to receive an input to cause an aggregation of the second collection of resources into the first collection of resources based on the first collection of resources being coupled with the first entity;
retrieve, responsive to receipt of the input, an electronic form associated with the aggregation of the second collection of resources into the first collection of resources;
cause the user interface to display a second element configured to receive information for one or more fields included in the electronic form; and
transmit, responsive to receipt of the information for the one or more fields included in the electronic form, one or more signals to provide the electronic form to a third entity configured to perform the aggregation of the second collection of resources into the first collection of resources.

2. The system of claim 1, the one or more processors to:
detect, responsive to monitoring the first collection of resources, that the first collection of resources reflects the aggregation of the second collection of resources into the first collection of resources; and
cause the user interface to display a third element configured to indicate that the second collection of resources reflects the aggregation of the first collection of resources into the second collection of resources.

3. The system of claim 1, wherein the aggregation of the second collection of resources into the first collection of resources includes modifying information associated with the second collection of resources to associate the second collection of resources with the first entity.

4. The system of claim 1, the one or more processors to:
receive, from the third entity, an indication of receipt of the electronic form; and
update, responsive to receipt of the indication, the user interface to display, via the user interface, a third element that identifies receipt of the electronic form.

5. The system of claim 1, the one or more processors to:
provide, via the user interface, a third element configured to receive an access code to verify the second collection of resources;
receive the access code via the third element of the user interface;
query a database to verify the second collection of resources;
verify, responsive to the query of the database, the second collection of resources; and
update the user interface to include an indication of verification of the second collection of resources.

6. The system of claim 1, the one or more processors to:
receive, via the user interface, an access code to verify the first collection of resources;
retrieve, based on the access code, one or more sets of information associated with the first collection of resources; and
update the user interface to display the one or more sets of information associated with the first collection of resources.

7. The system of claim 1, the one or more processors to:
receive, via the user interface, one or more sets of information associated with the account identifier to verify the account identifier;
query, responsive to receipt of the one or more sets of information, a database to search for a match between the one or more sets of information and one or more second sets of information stored in the database;
verify, responsive to detection of the match between the one or more sets of information and the one or more second sets of information stored in the database, the account identifier; and
cause, responsive to verification of the account identifier, the user interface to display the first element configured to receive the input to accept the aggregation of the second collection of resources into the first collection of resources based on the first collection of resources being coupled with the first entity.

8. The system of claim 1, the one or more processors to:
receive, via the user interface, the account identifier which identifies the first collection of resources and the first entity;
query, responsive to receipt of the account identifier, a database to search for one or more sets of information associated with the account identifier;
identify, responsive to the query of the database, a link between the account identifier and the second entity; and
determine, based on information associated with the second entity, that the second entity established the second collection of resources.

9. A method, comprising:
determining, by one or more processing circuits, for an account identifier, that a first collection of resources, established by a first entity, is coupled with the first entity;
detecting, by the one or more processing circuits, responsive to determining that the first collection of resources is coupled with the first entity, for the account identifier, that a second collection of resources, established by a second entity, has been decoupled from the second entity;
causing, by the one or more processing circuits, a user interface to display a first element configured to receive an input to cause an aggregation of the second collection of resources into the first collection of resources based on the first collection of resources being coupled with the first entity;
retrieving, by the one or more processing circuits, responsive to receipt of the input, an electronic form associated with the aggregation of the second collection of resources into the first collection of resources;
causing, by the one or more processing circuits, the user interface to display a second element configured to receive information for one or more fields included in the electronic form; and
transmitting, by the one or more processing circuits, responsive to receipt of the information for the one or more fields included in the electronic form, one or more signals to provide the electronic form to a third entity configured to perform the aggregation of the second collection of resources into the first collection of resources.

10. The method of claim 9, further comprising:
detecting, by the one or more processing circuits, responsive to monitoring the first collection of resources, that the first collection of resources reflects the aggregation of the second collection of resources into the first collection of resources; and
causing, by the one or more processing circuits, the user interface to display a third element configured to indicate that the second collection of resources reflects the aggregation of the first collection of resources into the second collection of resources.

11. The method of claim 9, wherein the aggregation of the second collection of resources into the first collection of resources includes modifying information associated with the second collection of resources to replace the second entity with the first entity.

12. The method of claim 9, further comprising:
receiving, by the one or more processing circuits, from the third entity, an indication of receipt of the electronic form; and
updating, by the one or more processing circuits, responsive to receipt of the indication, the user interface to display, via the user interface, a third element that identifies receipt of the electronic form.

13. The method of claim 9, further comprising:
providing, by the one or more processing circuits, via the user interface, a third element configured to receive an access code to verify the second collection of resources;
receiving, by the one or more processing circuits, the access code via the third element of the user interface;
querying, by the one or more processing circuits, a database to verify the second collection of resources;
verifying, by the one or more processing circuits, responsive to querying the database, the second collection of resources; and
updating, by the one or more processing circuits, the user interface to include an indication of verifying the second collection of resources.

14. The method of claim 9, further comprising:
receiving, by the one or more processing circuits, via the user interface, an access code to verify the first collection of resources;
retrieving, by the one or more processing circuits, based on the access code, one or more sets of information associated with the first collection of resources; and
updating, by the one or more processing circuits, the user interface to display the one or more sets of information associated with the first collection of resources.

15. The method of claim 9, further comprising:
receiving, by the one or more processing circuits, via the user interface, one or more sets of information associated with the account identifier to verify the account identifier;
querying, by the one or more processing circuits, responsive to receipt of the one or more sets of information, a database to search for a match between the one or more sets of information and one or more second sets of information stored in the database;
verifying, by the one or more processing circuits responsive to detecting the match between the one or more sets of information and the one or more second sets of information stored in the database, the account identifier; and
causing, by the one or more processing circuits, responsive to verification of the account identifier, the user interface to display the first element configured to receive the input to accept the aggregation of the second collection of resources into the first collection of resources based on the first collection of resources being coupled with the first entity.

16. The method of claim 9, further comprising:
receiving, by the one or more processing circuits, via the user interface, the account identifier which identifies the first collection of resources and the first entity;
querying, by the one or more processing circuits, responsive to receipt of the account identifier, a database to search for one or more sets of information associated with the account identifier;
identifying, by the one or more processing circuits, responsive to querying the database, a link between the account identifier and the second entity; and
determining, by the one or more processing circuits, based on information associated with the second entity, that the second entity established the second collection of resources.

17. A non-transitory computer readable medium including one or more instructions stored thereon and executable by a processor to:
determine, for an account identifier, that a first collection of resources, established by a first entity, is coupled with the first entity;
detect, responsive to determining that the first collection of resources is coupled with the first entity, for the account identifier, that a second collection of resources, established by a second entity, has been decoupled from the second entity;
cause a user interface to display a first element configured to receive an input to cause an aggregation of the second collection of resources into the first collection of resources based on the first collection of resources being coupled with the first entity;
retrieve, responsive to receipt of the input, an electronic form associated with the aggregation of the second collection of resources into the first collection of resources;
cause the user interface to display a second element configured to receive information for one or more fields included in the electronic form; and
transmit, responsive to receipt of the information for the one or more fields included in the electronic form, one or more signals to provide the electronic form to a third entity configured to perform the aggregation of the second collection of resources into the first collection of resources.

18. The non-transitory computer readable medium of claim 17, the one or more instructions further executable by the processor to:
detect, responsive to monitoring the first collection of resources, that the first collection of resources reflects the aggregation of the second collection of resources into the first collection of resources; and
cause the user interface to display a third element configured to indicate that the second collection of resources reflects the aggregation of the first collection of resources into the second collection of resources.

19. The non-transitory computer readable medium of claim 17, wherein the aggregation of the second collection of resources into the first collection of resources includes modifying information associated with the second collection of resources to replace the second entity with the first entity.

20. The non-transitory computer readable medium of claim 17, the one or more instructions further executable by the processor to:
receive, from the third entity, an indication of receipt of the electronic form; and
update, responsive to receipt of the indication, the user interface to display, via the user interface, a third element that identifies receipt of the electronic form.
